(19) United States
(12) Patent Application Publication
(10) Pub. No.: US 2025/0130748 A1
(43) Pub. Date: Apr. 24, 2025

(54) STORAGE MEDIUM THAT ENABLES SUPPORTING PRINT CONTROL OF INFORMATION PROCESSING APPARATUS, INFORMATION PROCESSING APPARATUS, AND METHOD OF CONTROLLING SAME

(71) Applicant: CANON KABUSHIKI KAISHA, Tokyo (JP)

(72) Inventor: DAISUKE HORI, Kanagawa (JP)

(21) Appl. No.: 18/919,822

(22) Filed: Oct. 18, 2024

(30) Foreign Application Priority Data
Oct. 19, 2023 (JP) 2023-180111

(51) Int. Cl. G06F 3/12

(52) U.S. Cl. CPC G06F 3/1297; G06F 3/1211; G06F 3/123

(57) ABSTRACT

A storage medium that makes it possible to extend, while preventing lowering of a processing speed of an information processing apparatus, a function of the information processing apparatus. The information processing apparatus has an application that is associated with print data generation software to thereby support the print data generation software. Whether or not a specific print application that can execute a unique print function has been installed is confirmed, and based on a result of the confirming, whether or not update of print function information used by the print data generation software is required is determined. The print function information is updated when it is determined that the update is required.

### BACKGROUND OF THE INVENTION

### Field of the Invention

The present invention relates to a storage medium, an information processing apparatus, and a method of controlling the same.

### Description of the Related Art

There is known a technique of providing a print instruction to a printing apparatus connected to a host computer by using a printer driver installed in the host computer as software for controlling the printing apparatus. In this technique, an operating system (OS) as basic software is installed in the host computer, and the printer driver is configured according to the specifications defined by the OS and is called from the OS for operation. A maker that provides the printing apparatus provides a printer driver adapted to the specifications of the OS, whereby it is possible to provide means for providing a print instruction to the printing apparatus by using the OS.

In recent years, in Windows (registered trademark), a class driver (hereinafter also referred to as the “standard driver”) which can be commonly used by printing apparatuses provided by a plurality of makers, respectively, is provided. The standard driver is included in the OS package and is easily made capable of being used when an arbitrary printing apparatus is connected to the host computer. Therefore, it is unnecessary to install a printer driver unique to the model, which is suitable for the printing apparatus, and this is highly convenient. Further, the standard driver is configured such that a print function can be designated according to Print Device Capabilities (PDC) generated based on information acquired from the connected printing apparatus. This makes it possible for a user using the standard driver to designate a print function based on the capabilities of the connected printing apparatus, in spite of using only one standard driver.

An application for extending functions (hereinafter also referred to as the “extension application”) can be associated with the standard driver. The extension application is provided by the maker that provides the printing apparatus and can execute a function which cannot be realized only by the standard driver (i.e. the extended function), by editing the PDC generated by the standard driver. Japanese Laid-Open Patent Publication (Kokai) No. 2020-126364 discloses a technique of extending the PDC by using an extension application.

Applications for performing printing include one that is equipped with a unique print function and acquires printing-related information unique to a printing apparatus from a printer driver provided by a maker of the printing apparatus, so as to fully use the functions of the printing apparatus. The maker enables these print applications to cooperate with the standard driver by extending the standard driver using the extension application.

However, if extension of the PDC is unnecessarily increased, this can bring about a problem that processing speed of the standard driver or the OS lowered by the increased extension results in lowering of the operation speed of making print settings and the printing speed, and the like.

### SUMMARY OF THE INVENTION

The present invention provides a storage medium that makes it possible to extend a function of an information processing apparatus while preventing lowering of a processing speed of the information processing apparatus, an information processing apparatus, and a method of controlling the same.

In a first aspect of the present invention, there is provided a non-transitory computer-readable storage medium storing a program for causing a computer to execute a method of controlling an information processing apparatus having an application that is associated with print data generation software to thereby support the print data generation software, wherein the method includes confirming whether or not a specific print application that can execute a unique print function has been installed, determining, based on a result of the confirming whether or not the specific print application has been installed, whether or not update of print function information used by the print data generation software is required, and updating the print function information when it is determined that the update is required.

In a second aspect of the present invention, there is provided a non-transitory computer-readable storage medium storing a program for causing a computer to execute a method of controlling an information processing apparatus having an application that is associated with print data generation software to thereby support the print data generation software, wherein the method includes extending, upon receipt of a request for extending print function information used by the print data generation software from a specific print application that can execute a unique print function, the print function information, and sending back the extended print function information to a print application which is an issuing source of the extension request.

According to the present invention, it is possible to extend a function while preventing lowering of the processing speed.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a printing system.

FIGS. 2A and 2B are diagrams schematically showing a software configuration of the printing system in which a standard driver is used.

FIG. 3 is a diagram showing an example of a print layout specification screen of a print application.

FIG. 4 is a diagram showing an example of an input image.

FIG. 5 is a diagram showing an example of another print layout specification screen.

FIG. 6 is a flowchart of a PDC processing process.

FIG. 7 is a diagram showing an example of PDC before update.

FIG. 8 is a diagram showing an example of PDC after update.

FIG. 9 is a diagram showing an example of Print Capabilities (PC) (capabilities information).

FIG. 10 is a flowchart of a screen construction process.

FIG. 11 is a flowchart of a PC sending-back process.

FIG. 12 is a diagram showing an example of a Print Ticket (PT) (print settings information) including dedicated tags.

FIG. 13 is a diagram showing an example of a PT after processing the dedicated tags.

### DESCRIPTION OF THE EMBODIMENTS

The present invention will now be described in detail below with reference to the accompanying drawings showing embodiments thereof. The embodiments described below are not intended to limit the invention as recited in the appended claims, and all combinations of features described in the embodiments are not absolutely essential to the solution of the invention. Note that the same components are denoted by the same reference numerals, and redundant description thereof is omitted.

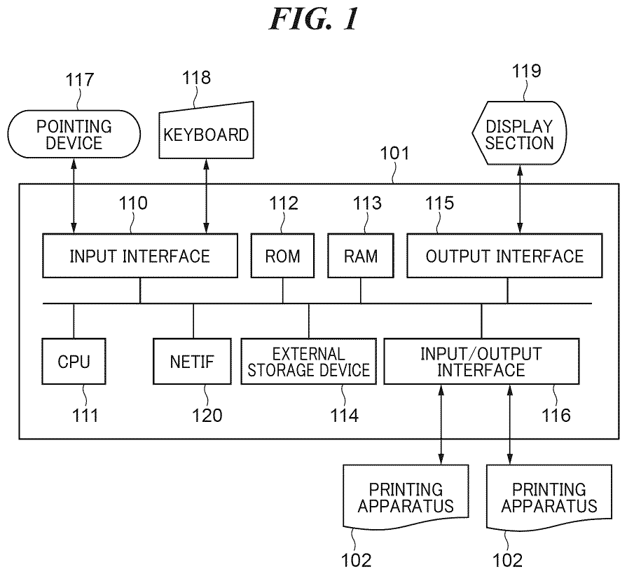

FIG. 1 is a block diagram showing a hardware configuration of a printing system including an information processing apparatus according to a first embodiment of the present invention. A host computer 101 is an example of the information processing apparatus. The host computer 101 includes an input interface 110, a central processing unit (CPU) 111, a read only memory (ROM) 112, a random access memory (RAM) 113, a network interface (NET IF) 120, an external storage device 114, an output interface 115, and an input/output interface 116. To the input interface 110, input devices, such as a keyboard 118 and a pointing device 117, are connected. To the output interface 115, a display device, such as a display section 119, is connected. The NET IF 120 is a network interface and performs control for transferring data to and from an external apparatus via a network.

The ROM 112 stores an initialization program. The external storage device 114 stores an application program group, an operating system (OS), print data generation software, and further, a variety of data items. The RAM 113 is used e.g. as a work memory when executing a variety of programs stored in the external storage device 114, whereby the variety of programs are made operable in the host computer 101.

Note that in the present embodiment, the CPU 111 performs processing operations of the programs stored in the ROM 112, to thereby execute functions, described hereinafter, of the host computer 101, and processes, described hereinafter. A printing apparatus 102 as a device is connected to the host computer 101 via the input/output interface 116.

Note that a plurality of printing apparatuses 102 can be connected to the host computer 101, and in the illustrated example in FIG. 1, two printing apparatuses 102 are connected. Although in FIG. 1, the host computer 101 and the printing apparatus 102 are configured as separate apparatuses, these can be configured as one information processing apparatus.

Note that as the printing apparatus 102, an inkjet printer that performs printing by ejecting ink onto a sheet surface will be described by way of example, but printing can be executed by using another method (such as the electrophotographic method). Further, the host computer 101 can be a desktop-type personal computer, a smartphone, or a laptop-type personal computer.

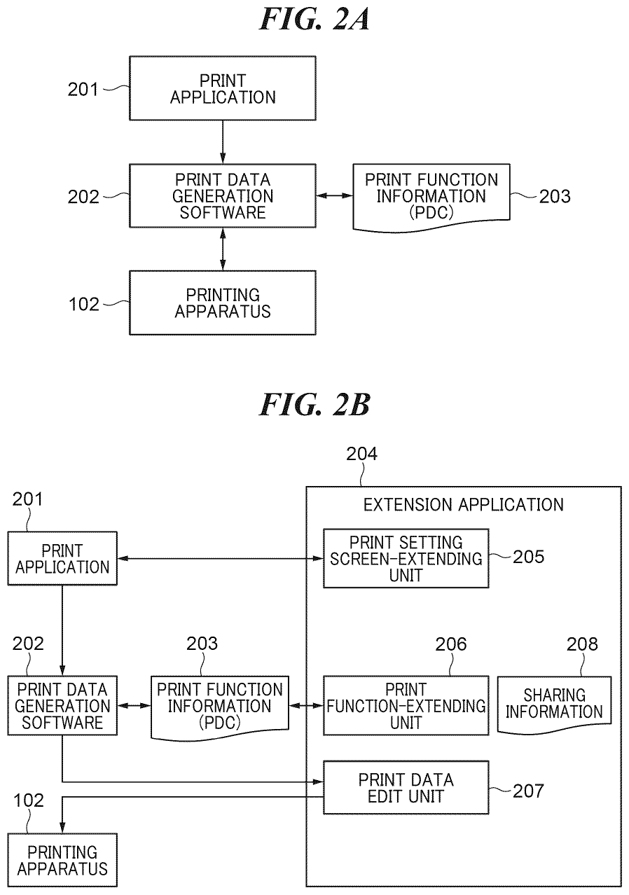

FIGS. 2A and 2B are diagrams schematically showing a software configuration of the printing system, in which a standard driver is used. Here, the host computer 101 in which Windows 11 (registered trademark) of Microsoft (registered trademark) is installed as the OS will be described by way of example. Further, the description will be given assuming a configuration using an “IPP Class Driver” as the standard driver. The “IPP Class Driver” is a printer driver that executes print processing according to the specifications of a standard print protocol called the Internet Printing Protocol (IPP) and is included in the OS package. This is not a printer driver specific to a model of the printing apparatus 102 but is a printer driver which can be commonly used by a plurality of printing apparatuses regardless of a maker (Manufacturer) or model.

FIG. 2A is a diagram showing a configuration of a general printing system using the “IPP Class Driver” (hereinafter referred to as the “print data generation software 202”) as the standard driver and the printing apparatus 102.

A print application 201 is software for generating contents (drawing data) to be printed and is e.g. a document generation application or a spreadsheet application. Upon receipt of a print request from a user, the print application 201 issues a print instruction to the OS. The print instruction includes print settings information for instructing operations of the print data generation software 202 and the printing apparatus 102. The print settings information is also called the Print Ticket (hereinafter referred to as the “PT”).

The print application 201 can display a print setting screen provided by one of the print data generation software 202, the OS, and the print application 201, so as to output the print settings information. The print setting screen includes setting items indicating print functions which can be set according to capabilities information (information enabling setting of the print settings) acquired from the print data generation software 202, and information on settings of the setting items. The capabilities information is also called the Print Capabilities (hereinafter referred to as the “PC”).

The print data generation software 202 determines the PC based on print function information 203. The print function information 203 is data describing all print functions which can be set, settings thereof, and an exclusive relationship between the settings. The print function information 203 is also referred to as the Print Device Capabilities (PDC). The print function information 203 is hereinafter sometimes described as the PDC 203 in an abbreviated form. The PDC 203 is included in a configuration file of the print data generation software 202 and disposed in the external storage device 114 as a file which cannot be changed without permission of the OS. The PDC 203 can also be dynamically generated by the print data generation software 202 or the OS. Specifically, the print data generation software 202 or the OS acquires attribute data of the printing apparatus 102 from the printing apparatus 102 and generates the PDC 203 according to attribute information in the acquired attribute data. Note that the attribute data refers to response information which can be acquired by issuing a Get-Printer-Attributes operation of the IPP to the printing apparatus 102. The response includes the attribute information indicating functions (capabilities of the printing apparatus) which can be designated in the printing apparatus 102 and settings related to the attribute information. This response is stored in the RAM 113.

With this configuration, the print data generation software 202 enables, according to each printing apparatus connected to the host computer 101, a user to designate a print function which can be used by the connected printing apparatus. That is, even in a case where a printing apparatus having a different function or a printing apparatus developed by a different maker is connected to the host computer 101, the print data generation software 202 enables a user to designate a usable print function according to the connected printing apparatus.

Note that as the print data generation software 202, the “UP Class Driver” installed in Windows 11 (registered trademark) can also be used. The “UP Class Driver” is a printer driver used in “Universal Print” as one form of cloud printing that performs printing via a server.

The OS generates intermediate data (also referred to as the input data) based on the print instruction output from the print application 201 and passes the generated intermediate data to the print data generation software 202. The data output for printing from the print application 201 includes data of the “Graphic Device Interface (GDI)” format (GDI data) and data of the “Extensible Markup Language (XML) Paper Specification” format (XPS data).

In a case where the “IPP Class Driver” is used as the print data generation software 202, the OS performs the following processing: If the data output from the print application 201 is the GDI data, the OS converts the GDI data output from the print application 201 to XPS data. Then, the OS passes the converted XPS data to the print data generation software 202 as the intermediate data. If the data output from the print application 201 is the XPS data, the OS passes the XPS data to the print data generation software 202 as the intermediate data. Note that the intermediate data includes drawing data as information on a picture (image) to be formed on a sheet surface and the print settings information set by a user.

The print data generation software 202 converts the acquired intermediate data to print data which can be interpreted by the printing apparatus 102 and transmits the print data to the printing apparatus 102. Note that the print data includes the drawing data as the information on a picture (image) to be formed on a sheet surface and print setting attribute information (attribute information for specifying print settings) generated based on the print settings information set by the user. The print setting attribute information includes attribute information indicating the functions which can be designated in the printing apparatus 102 (capabilities of the printing apparatus) and settings related to the attribute information.

The printing apparatus 102 performs printing on a sheet surface based on the print data transmitted from the print data generation software 202. At this time, the printing apparatus 102 forms the drawing data included in the print data on the sheet surface, by performing the operation according to the print setting attribute information included in the print data. The print setting attribute information includes information on print quality (such as image quality priority or speed priority), and attribute information for designating e.g. double-sided printing and the like and the settings of the attribute information. For example, in a case where the attribute information for designating double-sided printing and the settings indicating the operation of the double-sided printing are included in the print setting attribute information, the printing apparatus 102 executes double-sided printing.

FIG. 2B is a diagram showing a configuration in a case where an extension application 204 provided by the maker is associated with the print data generation software 202 and the printing apparatus 102. Note that components which are not particularly mentioned in the following description are the same as those described with reference to FIG. 2A.

The extension application 204 is software for supporting the print data generation software 202 and is a software program which is not included (packaged) in the OS in advance. Therefore, the user is required to operate the host computer 101 to download the extension application 204 from a server on the Internet and install the extension application 204. Alternatively, the extension application 204 can be automatically installed when the printing apparatus 102 is connected to the host computer 101. Specifically, when the printing apparatus 102 is connected to the host computer 101, the OS acquires device identification information from the printing apparatus 102. The OS downloads the extension application 204 associated with the acquired device identification information from the server via the Internet and installs the downloaded extension application 204. Therefore, the print data generation software 202 and the extension application 204 are stored in the host computer 101 as different files. Note that in a case where the extension application 204 is installed, the OS associates the extension application 204 with the print data generation software 202 and the printing apparatus 102.

The extension application 204 described in the present embodiment includes a print setting screen-extending unit 205, a print function-extending unit 206, and a print data edit unit 207. Further, the extension application 204 stores sharing information 208 which can be commonly accessed from the units. In actuality, the sharing information 208 is a file stored in the external storage device 114 or information stored in the RAM 113. The extension application 204 writes information into the sharing information 208 and reads the information from the sharing information 208 by using an Application Program Interface (API) provided by the OS.

When receiving a print request from a user, the print application 201 issues a print instruction to the OS. Similar to the configuration shown in FIG. 2A, under the configuration shown in FIG. 2B, the print application 201 can also display the print setting screen. In the configuration shown in FIG. 2B, a print setting screen provided by the print setting screen-extending unit 205 of the extension application 204 is displayed. The print setting screen-extending unit 205 is capable of performing extension such that items incapable of being displayed by a standard print setting screen are displayed and the items are more intelligible to look at.

The print function-extending unit 206 can edit the PDC 203 generated by the print data generation software 202 or the OS. With this, the print function-extending unit 206 can add a function which is not supported by the print data generation software 202, an exclusive relationship between the settings of the print functions, and so forth. The OS starts the print function-extending unit 206 when the extension application 204 is associated with the printing apparatus 102 and the print data generation software 202 for the first time. Further, the OS can start the print function-extending unit 206 at a timing other than the above-mentioned timing, such as a timing at which the OS is started or a timing at which printing is performed. With this, in a case where an optional device (such as a finisher) is added to the printing apparatus 102 later, whereby a function associated with printing is extended, the print function-extending unit 206 can detect the extended function and add the detected function to the PDC 203.

The print data edit unit 207 receives print data from the print data generation software 202 and can perform desired editing on the print data. After that, the print data is passed to the printing apparatus 102, and printing on a sheet surface is executed by the printing apparatus 102.

Note that the configuration of the extension application 204 for realizing the present embodiment is not limited to the configuration including all of the above-described functions (units) but include only some of the functions or can include another function. Further, the extension application 204 is sometimes simply referred to as the print software.

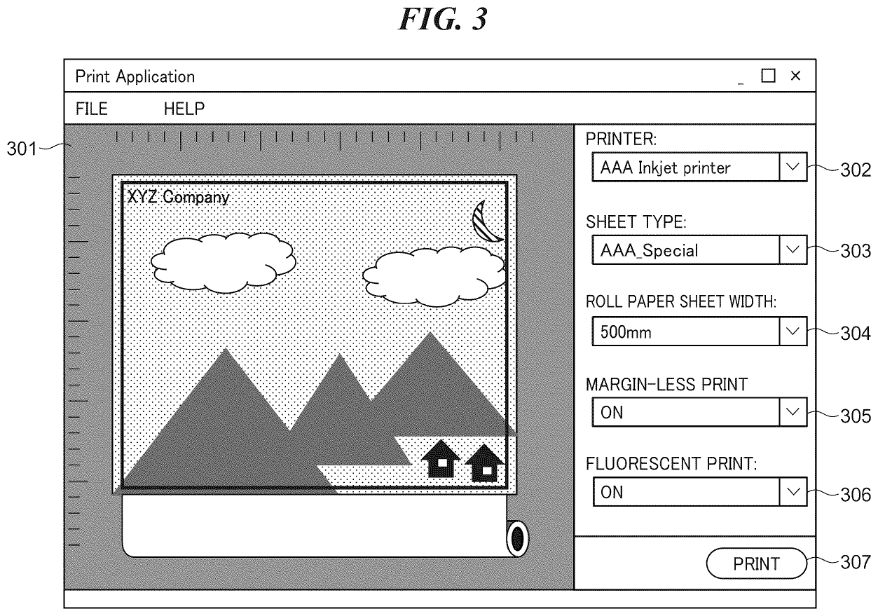

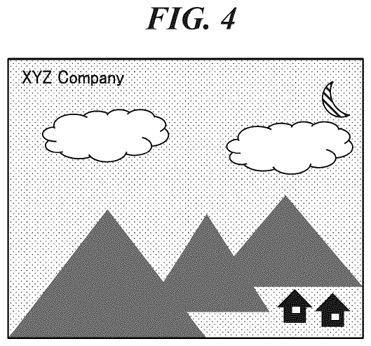

FIG. 3 is a diagram showing an example of a print layout specification screen of the print application 201 which can use a print function unique to the printer maker. FIG. 4 is a diagram showing an example of an input image.

The print application 201 acquires unique (specific) printing-related information (such as roll-paper width information) from a printer driver provided by the maker and uses the acquired information for making unique print settings and displaying a print preview, so as to make full use of the functions of the printing apparatus.

Although the method of inputting an image is not particularly illustrated, for example, the user can input an image by opening the explorer from a file menu of the print application 201. Also, the user can directly input an image to the print application 201 by dragging and dropping the image. Further, the format of the image is only required to be a format which can be interpreted by the print application 201, and for example, an image format, such as Bitmap or Tiff can be used. Further, a vector format, such as XML Paper Specification (XPS) or Enhanced Metafile (EMF), can be used.

A preview area 301 is an area for displaying a print image to be printed by the printing apparatus 102. In the illustrated example in FIG. 3, the input image shown in FIG. 4 is disposed such that the image is printed on a roll paper surface in a margin-less state. Note that the user can be enabled to directly adjust the size, the position, and so forth of the image, by using e.g. the pointing device while confirming the preview.

A printer setting 302 is a combo box for receiving designation of a printer driver to be used for printing. Here, the description will be given assuming that a printer driver manufactured by the maker and supported by the print application 201, is designated.

A sheet type setting 303 is a combo box for receiving designation of a type of a sheet to be used for printing. A roll paper width setting 304 is a combo box for receiving designation of a width of roll paper to be used for printing. The roll paper width designated here affects not only printing, but also expression of the width of roll paper displayed in the preview area 301. With reference to a ruler or the like displayed in the preview area 301, the user can confirm the width of roll paper used for printing and the size of the image, on the preview. Note that the roll paper width information is print settings information unique to the maker, and hence the standard print application cannot basically use the roll paper width setting 304.

A margin-less print setting 305 is a combo box for receiving designation on whether or not to execute printing having no margin (frame) by printing an image in a size larger than the print sheet. In the illustrated example in FIG. 3, the margin-less print setting 305 is set to on and hence the image is disposed on the sheet in a size slightly larger than the roll paper. Thus, an amount of extension off of the image is provided as described above, whereby even in a case where the image is printed in a state in which the sheet is displaced, printing is positively executed in a state having no margin.

Note that the print application 201 can acquire an amount of extension off in margin-less printing (margin-less printing extension-off amount) from the printer driver as the print information unique to the maker. With this, for example, in a case where the margin-less printing extension-off amount is 3 mm, the amount of extension off on the preview area 301 can be expressed as corresponding to an actual value of 3 mm, and the user can accurately confirm part of the image, which is to be cut off, before printing. Note that in a case where the standard print application is used, although margin-less printing can be designated, a degree of extension off of the image to be printed depends on a printer driver or a printing apparatus, and hence it is difficult to accurately express an extension-off position of the image on the preview.

A fluorescent print setting 306 is a combo box for receiving designation of printing using fluorescent ink uniquely mounted on the printing apparatus 102. In the printing using fluorescent ink, for example, it is possible to perform printing in a color tint which cannot be normally expressed, by printing a specific RGB value in one color of fluorescent ink. Further, it is also possible to perform printing in a state expanding the color region by mixing the fluorescent ink with the CMYK ink. Note that in a case where the fluorescent print setting 306 is set to on, a result of the printing can be pseudo-expressed in the preview area 301. The fluorescent print setting is one of the print settings unique to the maker, and the standard print application cannot use the fluorescent print setting 306.

The print application 201 can acquire the capabilities information necessary for the settings 303 to 306 by using the function of the OS, such as PC, with respect to a print queue of a printer driver selected in the printer setting 302 (see FIG. 3). Note that whether or not the capabilities information necessary for the settings 303 to 306 can be correctly sent back depends on a printer driver. In a case where these capabilities information items are not correctly sent back, the print application 201 can take an action, such as an action of excluding the printer driver from printing execution printer drivers or an action of graying out functions for which the capabilities information is insufficient.

A print button 307 is a button for sending the print settings information set in the settings 303 to 306 and layout information (drawing information) edited by the user in the preview area 301 to the print queue of the printer driver designated in the printer setting 302.

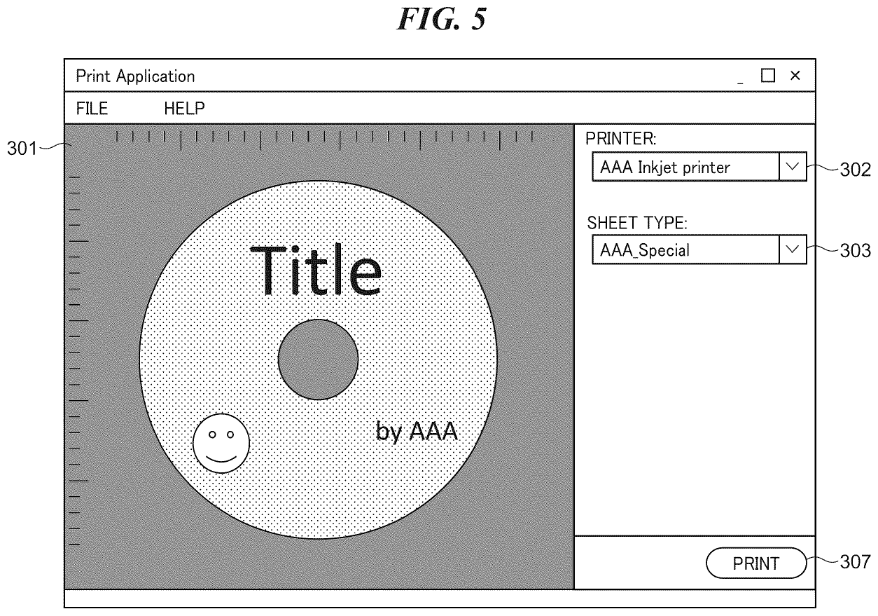

FIG. 5 is a diagram showing an example of another print layout specification screen of the print application 201. This example shows a screen for printing a label on a disc medium, such as a compact disc (CD). The user can perform desired data processing on a disc image displayed in the preview area 301 and then execute printing of the print queue of the printer driver designated in the printer setting 302. To acquire accurate information on a medium on which printing is to be executed, the print application 201 acquires radius information of the disc medium and the like, as printing-related information unique to the maker. This makes it possible to perform accurate display in the preview area 301 (see FIG. 3) by dynamically switching the radius information and the like also for a variety of disc media.

As described above, the print application 201 uses the printing-related information unique to the maker, for making unique print settings and displaying a print preview, as the capabilities information of the printer driver. With this, the user can fully use the functions of the printing apparatus 102 and confirm the accurate print layout even on the preview before printing. On the other hand, the print application 201 can fully exhibit the functions in a case where a printer driver manufactured by the maker that can provide unique printing-related information is set as a target of use, but cannot fully exhibit the functions in a case where a standard driver which can only provide standard printing-related information is set as a target of use.

To cope with the above-described problem, by extending the functions of the standard driver using the extension application 204, even in a case where the standard driver is set as the target of use, the print application 201 is enabled to fully exhibit the functions. However, in a case where the amount of extending the functions is large, a demerit, such as lowering of the operation speed of making print settings and the printing speed, can be caused. In a case where all of the printing-related information items necessary for each print application are uniformly incorporated in the standard driver, this demerit is increased.

To prevent this, in the present embodiment, although details will be described hereinafter, by suppressing extension of the standard driver to the necessary minimum, the specific print application 201 is enabled to use the full functions even when combined with the standard driver, while reducing the demerit of lowering of the printing speed.

The print application which can use a print function unique to the maker is referred to as the “specific print application” when distinguishing the same from the standard print application which can execute only general print functions.

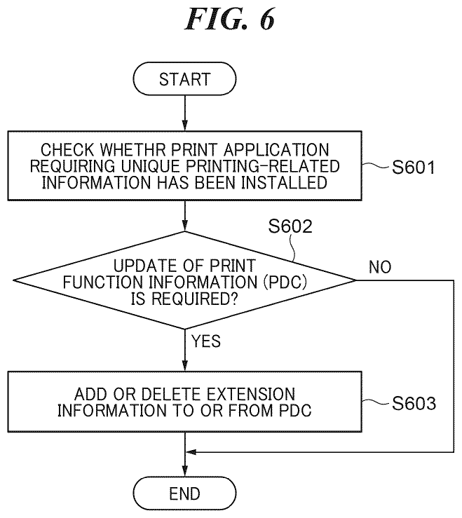

FIG. 6 is a flowchart of a PDC processing process. This process is a process performed by the print function-extending unit 206 included in the extension application 204, for processing the PDC 203. Although the process will be described assuming that the print function-extending unit 206 is the execution entity of this process, in actuality, the associated function is realized by the CPU 111 that executes an associated program. That is, this process is realized by the CPU 111 that loads the associated program stored in the ROM 112 into the RAM 113 and executes the loaded program. This process is started by the OS at a desired timing. For example, this process is executed when the extension application 204 is associated with the printing apparatus 102, or when the OS is started, or when the print setting screen-extending unit 205 is started, or the like.

Note that the present process is executed assuming that the PDC 203 (PDC on which processing specific to the maker except processing for the specific print application has been performed) as the basis has already been generated by a process other than the present process.

First, in a step S601, the print function-extending unit 206 confirms whether or not installation of the print application 201 requiring the unique printing-related information (i.e. specific print application) in the host computer 101 has been performed. Whether or not the installation has been performed is confirmed as follows:

For example, the installation can be confirmed by referring to a registry or specific file which has been generated in advance by the specific print application 201. Note that in a case where the extension application 204 cannot directly access the registry or the specific file for the sake of security, it is possible to indirectly access the registry or the specific file, by using an API of “Full Trust Process Launcher”.

Further, if the print application is a print application which copes with a startup using a Uniform Resource Identifier (URI), it is possible to confirm whether or not the installation has been performed by using an API of “Query Uri Support Async”. For example, it is possible to determine whether or not the print application in question has been installed, depending on whether or not the print application can be started by using the URI.

In a step S602, the print function-extending unit 206 determines whether or not update of the print function information (PDC 203) used by the print data generation software 202 is required, based on a result of confirming whether or not the installation has been performed.

Here, for example, in a case where it is determined that the specific print application has been installed and the extension information required to execute the specific print application is not described in the PDC 203, the print function-extending unit 206 determines that the update is required. That is, in a case where an installed specific print application has been newly found, whether or not the necessary extension information associated with the specific print application is described in the PDC 203 is confirmed, and if not described, it is determined that the update is required.

Note that, by storing the installation information of the specific print application and the processing history of the PDC 203 in the sharing information 208 every time, the print function-extending unit 206 can also quickly determine, based on the history information, whether or not the update of the PDC 203 is required.

Here, for example, if it is determined that the specific print application has been uninstalled and that the extension information required to execute the specific print application is described in the PDC 203, the print function-extending unit 206 determines that the update is required. This is because, in this case, it is necessary to delete the unnecessary extension information from the PDC 203.

If it is determined in the step S602 that the update is required, the print function-extending unit 206 proceeds to a step S603, whereas if it is determined that the update is not required, the present process is terminated.

In the step S603, the print function-extending unit 206 updates the PDC 203 by adding or deleting the extension information to or from the PDC 203 according to a situation in which the update is determined to be required. That is, in a case where it is determined that the update is required because the specific print application has been installed and the extension information required to execute the specific print application is not described in the PDC 203, the extension information is added to the PDC 203. With this, the necessary function is properly extended, and addition of an unnecessary function is avoided, which prevents lowering of the processing speed.

On the other hand, in a case where it is determined that the update is required because the specific print application has been uninstalled, and the extension information required to execute the specific print application is described in the PDC 203, the described extension information is deleted from the PDC 203. After execution of the step S603, the print function-extending unit 206 terminates the present process.

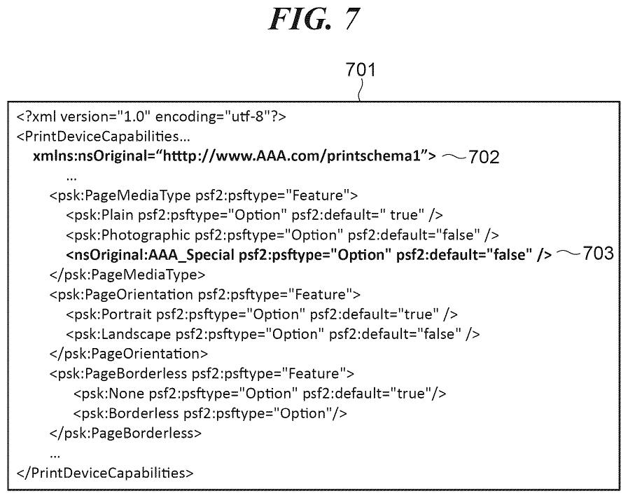

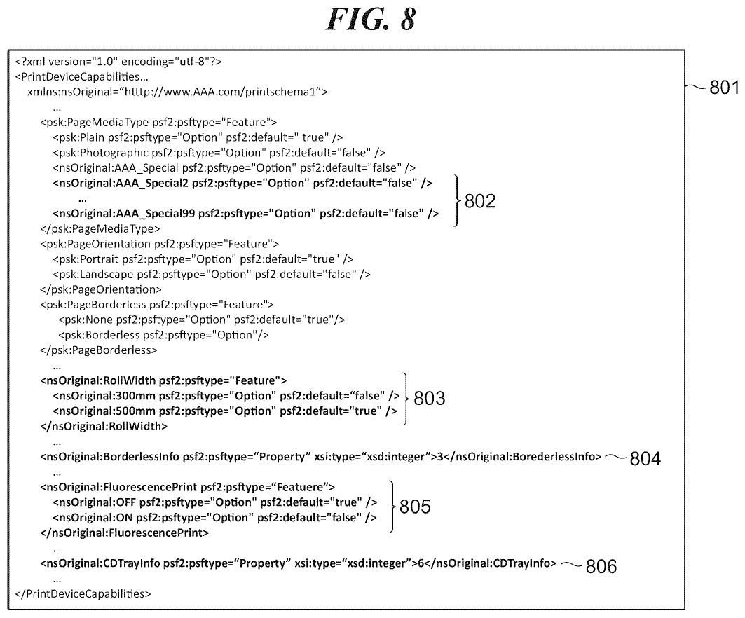

FIG. 7 is a diagram showing an example of the PDC 203 before being processed in the step S603 (before update). FIG. 8 is a diagram showing an example of the PDC 203 after being processed in the step S603 (after update).

In the PDC 203 (see FIG. 7) before update, indicated by an example 701, the standard printing-related information supported by the standard driver is described. In the PDC 203 before update, further, information added by the extension application 204 in advance (a name space 702 and a sheet type 703 uniquely defined by the maker: AAA_Special) is described. On the other hand, in the PDC 203 after update, which is indicated by an example 801, information items 802 to 806 have been newly added for the unique print application.

In the information 802, AAA_Special2 to AAA_Special99 have been newly added as the types of sheets which can be handled by the printing apparatus 102. For example, the information is unnecessary for the general application but is added for the specific print application 201 e.g. in a case where supporting of a lot of these print sheets is desired. In a case where the specific print application 201 has not been installed, these information items are not added. Therefore, it is possible to prevent the inconvenience that sheet types unnecessary for the general application are viewed and the user has difficulty in selecting a sheet type.

In the information 803, information concerning a width of roll paper which can be handled by the printing apparatus 102 has been added. This addition is performed e.g. in a case where the specific print application 201 sets the roll paper width and performs expression for preview. In the information 804, information concerning the margin-less printing extension-off amount of the printing apparatus 102 has been added. This addition is performed e.g. in a case where the specific print application 201 aims to accurately perform preview expression based on the information on the margin-less printing extension-off amount.

In the information 805, information concerning fluorescent printing which can be handled by the printing apparatus 102 has been added. This addition is performed e.g. in a case where the specific print application 201 performs fluorescent printing. In the information 806, information concerning a disc medium which can be handled by the printing apparatus 102 has been added. Here, radius information (6 mm) of the disc is described by way of example, and this addition is performed e.g. in a case where the specific print application 201 performs printing on a disc medium.

Note that in the step S603, the print function-extending unit 206 can finely control addition of the information 802 to 806 or other information depending on a state of compatibility between the specific print application 201 and the unique function. If the specific print application has not been installed or if a unique function is not equipped, the print function-extending unit 206 does not add the description of the information 802 to 806. This makes it possible to prevent lowering of the performance when operating the standard driver. Particularly, in a case where it is necessary to add a large amount of information as in the case where a lot of types of sheets are added in the information 802, this largely affects lowering of the performance, and hence the effect obtained by preventing addition of the description of the information 802 to 806, which are not necessary, is high.

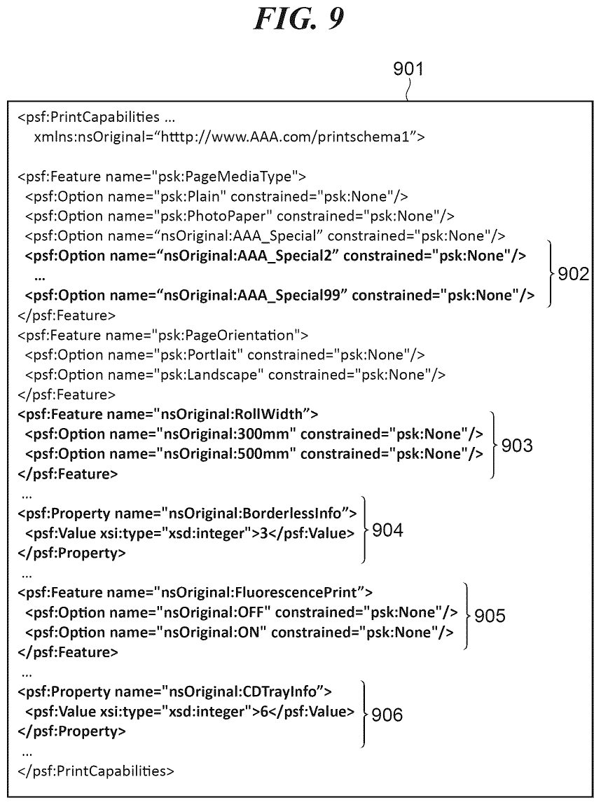

FIG. 9 is a diagram showing an example of the PC (capabilities information) generated by the OS based on the updated PDC 203 indicated by the example 801. Information items 902 to 906 in the PC indicated by an example 901 correspond to the information items 802 to 806, respectively. The specific print application 201 executes the unique print function based on the updated PDC 203. Therefore, the specific print application 201 is enabled to perform unique print preview display and print control also with respect to the standard driver based on the information items 902 to 906 of the PC indicated by the example 901.

According to the present embodiment, whether or not the update of the print function information (PDC 203) used by the print data generation software is required is determined based on a result of confirming whether or not the specific print application has been installed. Then, if it is determined that the update is required, the print function information is updated. With this update, the necessary extension information is added, whereby the function is extended. Further, since unnecessary extension information is not added, a situation where the print setting operation becomes slow or the printing speed is lowered is avoided. With this, it is possible to extend the function while preventing lowering of the processing speed.

Further, since the extension information which becomes unnecessary due to uninstallation is deleted, it is possible to prevent lowering of the performance of the standard driver.

Further, in a case where it is determined that the update is not required so that the extension information is not described in the PDC 203, or in a case where the extension information is deleted by the update, unnecessary information is prevented from being viewed by a user.

Next, a second embodiment of the present invention will be described. In the first embodiment, the description is given of the example in which the processing on the PDC 203 is switched according to whether or not the specific print application has been installed. On the other hand, in the second embodiment of the present invention, a description will be given of an example in which the specific print application directly instructs change of the PDC 203. Not that the following description will be given mainly of different points from the first embodiment, and points which are not particularly referred to are assumed to be the same as those of the first embodiment.

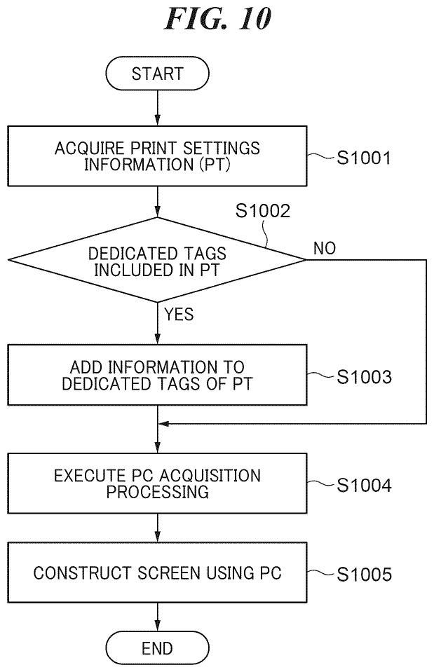

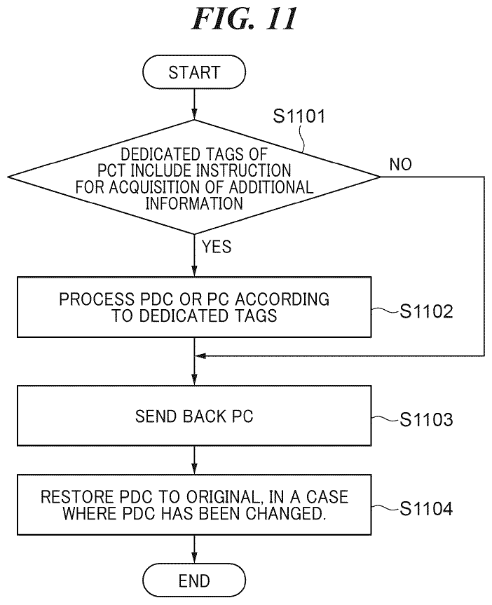

FIG. 10 is a flowchart of a screen construction process performed by the print application 201. FIG. 11 is a flowchart of a PC sending-back process performed by the extension application 204.

The screen construction process in FIG. 10 is a process performed when the print application 201 requests necessary information to the extension application 204 associated with the standard driver and constructs a screen. Although the process will be described assuming that the print application 201 is the execution entity of this process, in actuality, the associated function is realized by the CPU 111 that executes an associated program. This process is executed when the application is started or when the screen is displayed.

The PC sending-back process in FIG. 11 is executed when a PT is received. Although the process will be described assuming that the print function-extending unit 206 is the execution entity of this process, in actuality, the associated function is realized by the CPU 111 that executes an associated program.

First, the screen construction process will be described. In a step S1001 in FIG. 10, the print application 201 acquires the default PT (print settings information) with respect to a print queue of the printer driver designated in the printer setting 302 and proceeds to a step S1002.

In the step S1002, the print application 201 determines whether or not dedicated tags for requesting unique printing-related information are included in the PT. Here, the PT including dedicated tags will be described.

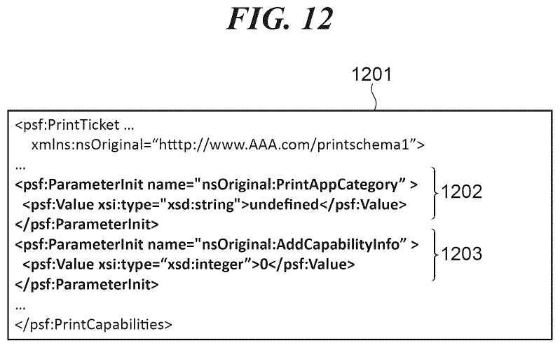

FIG. 12 is a diagram showing an example 1201 of the PT including dedicated tags. In the example 1201 (see FIG. 12), the PDC 203 has been processed by the extension application 204 in advance, whereby dedicated tags 1202 and 1203 have been added. <PrintAppCategory> in the dedicated tag 1202 is a tag for notifying a name of a print application which requests the unique printing-related information and a category name. That is, the dedicated tag 1202 includes a name of a print application which is an issuing source of the PDC extension request and a name indicating a classification of the extension information to be added. As the initial value of the dedicated tag 1202, “undefined” is set.

<AddCapabilityInfo> in the dedicated tag 1203 is a tag for finely designating the printing-related information desired to be uniquely requested. That is, the dedicated tag 1203 includes a detailed value of the extension information. In the dedicated tag 1203, “0” is set as an initial value.

If it is determined in the step S1002 that the dedicated tags 1202 and 1203 are included in the PT, the print application 201 proceeds to a step S1003. On the other hand, if the dedicated tags 1202 and 1203 are not included in the PT, the print application 201 determines that the unique printing-related information cannot be requested and proceeds to a step S1004.

In the step S1003, the print application 201 inputs necessary information in the dedicated tags 1202 and 1203 of the PT. That is, the contents of the extension request are specified by the dedicated tags 1202 and 1203, included in the PT. For example, when the extension request is desired to be included, the print application 201 describes information desired to be added (not only the print application name and the category name, but also a detailed value of the extension information) in the dedicated tags 1202 and 1203.

Note that the print application 201 which does not require the unique printing-related information (non-specific print application) can skip all processing operations concerning the unique printing-related information without processing the dedicated tags nor changing the initial values of the dedicated tags. That is, the dedicated tags 1202 and 1203 which are not changed from the initial values mean that there is no extension request.

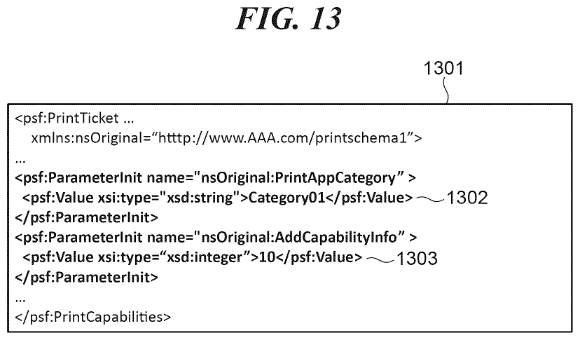

FIG. 13 is a diagram showing an example of the PT after processing the dedicated tags. In an example 1301 shown in FIG. 13, by executing the processing in the step S1003, “Category01” is described in the dedicated tag 1302 as the category name of the print application, and “10” is described in the dedicated tag 1303 as a designated value of the requested printing-related information.

Note that although the specification and the use form of the dedicated tags are not particularly limited, it is possible to roughly instruct the printing-related information desired to be added by the extension application 204 by designation of the dedicated tag 1302. For example, in a case where “Category01” is designated, this means that the print application is the specific print application requiring the roll paper width information and the information on the margin-less printing extension-off amount. Note that the application name can be directly notified. By determining the meaning of these designated values in advance, it is possible to designate detailed contents.

For example, in the dedicated tag 1303, by making an arrangement that a hexadecimal number 0×1 requests the information 902 (see FIG. 9), it is possible to finely designate necessary request information. Further, it can be arranged that hexadecimal numbers 0×2, 0×4, 0×8, and 0×10 request the information 903, the information 904, the information 905, and the information 906, respectively.

In the example 1301 shown in FIG. 13, the decimal number “10” is designated, and this means that 0×02 and 0×08 are designated, and hence it is possible to request the information 903 and the information 905. Note that the specification of the dedicated tag is not particularly limited, but only one of the dedicated tags 1302 and 1303 can be used, or the necessary request information can be designated by using a value obtained by adding up both the values.

After execution of the step S1003, the print application 201 proceeds to the step S1004. In the step S1004, the print application 201 executes PC acquisition processing using the PT processed in the step S1003 and proceeds to a step S1005. Here, acquisition of the PC is requested to the standard driver and the extension application 204 via the OS. In response to this, the PC is sent back to the print application 201 in a state in which the information extended e.g. by the extension application 204 is added (details will be described hereinafter with reference to FIG. 11).

In the step S1005, by using the PC acquired in the step S1004, the print application 201 updates the preview area 301 to which the unique information has been added and displays the variety of print setting items, followed by terminating the present process. With this, the specific print application 201 can execute the unique print function based on the extended print function information.

Next, the PC sending-back process in FIG. 11 will be described. This process is performed when the print function-extending unit 206 of the extension application 204 receives a PC request via the OS and the standard driver.

First, in a step S1101, the print function-extending unit 206 determines whether or not an instruction for requesting additional information using dedicated tags, i.e. an extension request is included in the PT passed as an argument from the print application 201 in the step S1004. Then, if an extension request is included in the PT, the print function-extending unit 206 proceeds to a step S1102, whereas if an extension request is not included in the PT, the print function-extending unit 206 proceeds to a step S1103. When the print function-extending unit 206 receives the PT in which an extension request is described in dedicated tags, this means that the print function-extending unit 206 receives the extension request.

Thus, the request for extending the PDC 203 is received in a state included in the PT received from the specific print application 201. When values are set in the dedicated tags 1202 and 1203 (setting items), this means that there is the extension request.

In the step S1102, the print function-extending unit 206 processes the PDC 203 or directly processes the PC according to the description in the dedicated tags. Note that in a case where the PDC 203 is processed, the OS generates the PC based on the processed PDC 203 after that. Note that the method of processing the PDC 203 is the same as described in the first embodiment (see FIGS. 8 and 9).

In the step S1103, the print function-extending unit 206 sends back the PC to the print application which is the issuing source of the PDC extending request. via the OS, and proceeds to a step S1104. The PC sent back in this step is received by the print application 201 in the step S1004. Note that in a case where an extension request is not included in the received PT, since the process proceeds from the step S1101 to the step S1103, the PC which has not been extended is sent back to the print application which is the transmission source of the PT.

In the step S1104, in a case where the PDC 203 has been processed in the step S1102, the print function-extending unit 206 performs processing for restoring the PDC 203 to that before being processed, followed by terminating the present process. Since the PDC 203 is restored to the original in the step S1104, for example, even in a case where another standard (non-specific) print application requests a PC after that, the PC before being processed is sent back.

According to the present embodiment, when a request for extending the PDC 203 is received from the specific print application, the PDC 203 is extended (S1102). Then, the PC processed based on the extended PDC 203 is sent back to the print application which is the issuing source of the extension request (S1103). With this, in extending the function while preventing lowering of the processing speed, it is possible to obtain the same advantageous effects as provided by the first embodiment.

Particularly, since the PC is processed only in a case where the print application designates extension using dedicated tags of the PT, it is possible to further suppress the demerit generated due to extension.

Further, in a case where the PDC is extended and the PC based on the extended PDC is sent back to the print application which is the issuing source of the extension request, the PDC is restored to that before extension (S1104). With this, the processed PC is not sent back to the non-specific print application, and hence an influence generated due to the processing is avoided. Therefore, the non-specific print application can execute the print control using the PC which is not extended, and hence lowering of the performance is prevented.

The present invention has been described heretofore based on the embodiments thereof. However, the present invention is not limited to these specific embodiments, but it is to be understood that the invention includes various forms within the scope of the gist of the present invention. Part of the above-described embodiments can be appropriately combined.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-180111 filed Oct. 19, 2023, which is hereby incorporated by reference herein in its entirety.

What is claimed is:

1. A non-transitory computer-readable storage medium storing a program for causing a computer to execute a method of controlling an information processing apparatus having an application that is associated with print data generation software to thereby support the print data generation software,
wherein the method comprises:
confirming whether or not a specific print application that can execute a unique print function has been installed;
determining, based on a result of the confirming whether or not the specific print application has been installed, whether or not update of print function information used by the print data generation software is required; and
updating the print function information when it is determined that the update is required.

2. The storage medium according to claim 1, wherein the determining includes determining that the update is required, in a case where the specific print application has been installed and it is determined that extension information required in order to execute the specific print application is not described in the print function information, and
wherein the updating includes adding the extension information to the print function information when it is determined that the update is required.

3. The storage medium according to claim 1, wherein the determining includes determining that the update is required, in a case where the specific print application has been uninstalled and it is determined that extension information required in order to execute the specific print application is described in the print function information, and
wherein the updating includes deleting the extension information from the print function information when it is determined that the update is required.

4. The storage medium according to claim 1, wherein the confirming includes confirming whether or not the specific print application has been installed, based on a result of the confirming whether or not the specific print application has been started by using a Uniform Resource Identifier (URI).

5. The storage medium according to claim 1, wherein the specific print application executes the unique print function based on the updated print function information.

6. A non-transitory computer-readable storage medium storing a program for causing a computer to execute a method of controlling an information processing apparatus having an application that is associated with print data generation software to thereby support the print data generation software,
wherein the method comprises:
extending, upon receipt of a request for extending print function information used by the print data generation software from a specific print application that can execute a unique print function, the print function information; and
sending back the extended print function information to a print application which is an issuing source of the extension request.

7. The storage medium according to claim 6, wherein the sending back includes transmitting capabilities information processed based on the extended print function information to the print application which is the issuing source of the extension request.

8. The storage medium according to claim 6, wherein the method further comprises restoring the print function information to a state before extension, in a case where the print function information has been extended, and the extended print function information has been sent back to the print application which is the issuing source of the extension request.

9. The storage medium according to claim 6, wherein the extension request is received in a form included in print settings information received from the specific print application, and
wherein contents of the extension request are specified by setting items included in the print settings information.

10. The storage medium according to claim 9, wherein a name of the print application which is the issuing source of the extension request, or a name indicating a classification of extension information to be added is included in the setting items.

11. The storage medium according to claim 10, wherein a detailed value of the extension information is further included in the setting items.

12. The storage medium according to claim 9, wherein the sending back includes sending back the print function information in a state not extended, to the print application which is the transmission source of the print settings information, in a case where the extension request is not included in the received print settings information.

13. The storage medium according to claim 6, wherein the print application which is the issuing source of the extension request executes the unique print function, based on the extended print function information.

14. An information processing apparatus having an application that is associated with print data generation software to thereby support the print data generation software, comprising:
a confirmation unit configured to confirm whether or not a specific print application that can execute a unique print function has been installed;
a determination unit configured to determine whether or not update of print function information used by the print data generation software is required, based on a result of the confirming whether or not the specific print application has been installed; and
an update unit configured to update the print function information when it is determined that the update is required.

15. An information processing apparatus having an application that is associated with print data generation software to thereby support the print data generation software, comprising:
an extension unit configured to extend, upon receipt of a request for extending print function information used by the print data generation software from a specific print application that can execute a unique print function, the print function information; and
a sending-back unit configured to send back the extended print function information to a print application which is an issuing source of the extension request.

16. A method of controlling an information processing apparatus having an application that is associated with print data generation software to thereby support the print data generation software, comprising:
confirming whether or not a specific print application that can execute a unique print function has been installed;
determining whether or not update of print function information used by the print data generation software is required, based on a result of the confirming whether or not the specific print application has been installed; and
updating the print function information when it is determined that the update is required.

17. A method of controlling an information processing apparatus having an application that is associated with print data generation software to thereby support the print data generation software, comprising:
extending, upon receipt of a request for extending print function information used by the print data generation software from a specific print application that can execute a unique print function, the print function information; and
sending back the extended print function information to a print application which is an issuing source of the extension request.
